(19) United States
(12) Patent Application Publication
(10) Pub. No.: US 2025/0367705 A1
(43) Pub. Date: Dec. 4, 2025

(54) COMPLEX MODULATED HIGH FREQUENCY/LOW FREQUENCY VIBRATION TOOL

(71) Applicant: Mario Plasencia, La Vue-des-Alpes (CH)

(72) Inventor: Mario Plasencia, La Vue-des-Alpes (CH)

(21) Appl. No.: 19/223,642

(22) Filed: May 30, 2025

Related U.S. Application Data
(60) Provisional application No. 63/654,710, filed on May 31, 2024.

(51) Int. Cl. B06B 1/16

(52) U.S. Cl. CPC B06B 1/166

(57) ABSTRACT

The invention provides a novel vibration generation tool that utilizes a complex modulated high frequency actuator to create modulated low frequency hammer vibrations or compounded complex modulated high frequency and corresponding complex modulated low frequency hammer vibrations applied to a structure. Novel application of complex modulated actuator driving signals are used to stimulate wideband frequency response vibrations from a structure under treatment to facilitate improved cleaning, stress relief, screen de-blinding, and process improvement for a wide range of applications where wideband frequency vibrations may be helpful. It is especially helpful in applications where scale or fouling tends to accumulate and requires periodic or full-time remediation. The modulated high frequency/low frequency vibration tool may be used as a handheld portable tool, mounted to a robotic system, or fixed to a structure for long-term or periodic operation.

### TECHNICAL AREA

The invention generally relates to devices that utilize modulated compounded sonic high frequency and low frequency vibrations or modulated sonic vibrations, and more particularly, relates to apparatus for cleaning, antifouling, screen de-blinding, impact hammering, material stress relief, or liquid processing a medium.

### BACKGROUND

In all industries where heat exchangers are used, it is very common that the liquids under treatment or the liquids used to exchange heat will cause fouling and build-up of unwanted substances on the heat exchanger surfaces. Such fouling often results in degraded heat exchanger performance thereby reducing energy efficiency that results in higher energy costs, higher CO2 emissions, reduced production capacity, as well as higher maintenance costs and lost production time when heat exchanges must be taken offline and/or removed for cleaning. Similarly. such fouling and lost energy efficiency can be a significant problem for evaporators, pipes, pumps, valves, and screens where liquids are present and in applications where dry matter can accumulate.

Offline cleaning and maintenance is in itself a time consuming and expensive process, especially for large tube bundle heat exchanges such as those used in Oil and Gass refineries. Thorough cleaning often requires a production stop, special equipment and technicians for removal and transport of the tube bundle to a cleaning site. Then high-pressure washing can be used or in some cases special large capacity ultrasonic baths can be used to clean the tube bundles. Cleaning may still have limitations due to shadowing effects of the tubes preventing high pressure spray or ultrasonic cavitation getting to all tube surfaces and tubes in the center of the bundle. Furthermore, these methods have limitations in cleaning the interior tube surfaces.

Generally, industries and marine environments with surfaces and screens in contact with wet environments or excess dry matter are susceptible to similar fouling issues. Those surfaces in a wet environment often encounter fouling from scale, biological films, and living organisms. One example is that there are screens or pipes used in hydroelectric plants, waterways, and boat hull surfaces that can become fouled by materials such as biofilm, mussels, and algae. Mussels are one of the biggest culprits and once attached are difficult to remove, which leads to reduced flow, increase energy use, damage, and downtime. In environments with excessive dry material screens can blind and solid surfaces can become coated with a heavy layer of fouling material. In screening operations blinding can severely restrict the efficiency of the operation and result in reduced productivity, increased energy consumption, and higher maintenance costs.

Attempts have been made to use vibrational forces to reduce fouling. For example, ultrasonic systems are widely used to clean small elements by inducing cavitation in a liquid in contact with the surface to be cleaned and/or by vibrating a surface. Although not widely used due to their limited capabilities there are systems designed to be attached to large plate type or tube bundle heat exchangers and pipes to prevent fouling.

A commercial product sold by Orange Cleantech Inc., Newmarket, Canada, uses vibration energy directly coupled to the external tube sheet of a tube bundle or the outer surface of a pipe to provide a clean-in-place solution.

Another commercial solution is offered by Altum Technologies Oy, Helsinki, Finland, and uses a multitude of ultrasonic transducers mounted to a segmented belt that can be wrapped around and clamped to a large element to be cleaned such as a pipe or heat exchanger. Their technology and approach to prevention of heat exchanger fouling is disclosed in the company published information and in patent U.S. Pat. No. 11,224,901B2 that discloses an invention that relates to systems and methods for cleaning of devices, such as heat exchangers. According to the invention, controlled cavitation is created at predetermined positions within a device. The cavitation is done by mechanical waves, such as ultrasound waves, generated by transducers, wherein the waves are based on output of time-reversal wave form analysis of the device structures. Additionally, patent U.S. Pat. No. 11,624,566B2 discloses a methods for cleaning of devices, such as heat exchangers, in particular to methods wherein machine learning systems, such as trained neural networks are used for indicating the fouling status during the cleaning processes. and US20220107147A1 discloses methods and systems for cleaning devices holding fluid such as heat exchanges. The cleaning is performed by using a system such as a transducer assembly including at least one pair of protrusions acting as point-like pressure sources or at least one substantially circular protrusion acting as a substantially circular point-like pressure source, coupled to an outer surface of the device to be cleaned.

US20070267176A1 and U.S. Pat. No. 7,836,941B2 disclose a method wherein fouling of heat exchange surfaces is mitigated by a process in which a mechanical force is applied to a fixed heat exchanger to excite a vibration in the heat exchange surface and produce shear waves in the fluid adjacent to the heat exchange surface. The mechanical force is applied by a dynamic actuator coupled to a controller to produce vibration at a controlled frequency and amplitude that minimizes adverse effects to the heat exchange structure. The dynamic actuator may be coupled to the heat exchanger in place and operated while the heat exchanger is online.

Patents U.S. Pat. No. 6,863,136B2, US20070193757A1, U.S. Pat. No. 7,156,189B1, U.S. Pat. No. 7,740,088B1, U.S. Pat. No. 8,640,786B2, U.S. Pat. No. 8,960,325B2, and US20190299252A1 all disclose inventions that utilize an ultrasonic actuator configured to stimulate a solid impactor or free mass configured to be displaced by the vibrations generated by the piezoelectric actuator for causing some form of drilling, hammering and sonic impacts. Ultrasonic actuators typically in the range of 20 kHz to 40 kHz are widely applied in industries requiring high-frequency vibrations, yet they inherently suffer from constraints in axial displacement. Industrial actuators operating at ultrasonic frequencies typically generate vibrations in the range of 4 to 12 micrometers. Although shaped horns and booster elements can increase the vibration displacement there is inherent limited displacement capability, largely dictated by the material properties and design of piezoelectric systems that power them. As a consequence, in applications where robust mechanical coupling or significant vibratory energy is required, ultrasonic actuators can fall short of achieving the desired performance.

In the field of liquid processing, ultrasonic or low frequency vibration energy may be used to aid in mixing or accelerating a physical or chemical process. While ultrasonic liquid processors are well suited to deliver efficient energy to induce cavitation in low viscosity liquids it becomes less efficient in high viscosity liquids where transmission and penetration of the acoustic energy is dampened. As such the effective sound field range is reduced. In high viscosity liquids there is a need for a solution that can induce stirring to effect displacement and movement of materials close to the vibrating element. Such stirring will allow improved contacting of high frequency vibrations to act on materials. A compounded complex modulated sonic high frequency and correspondingly modulated low frequency apparatus would allow such stirring and improved cavitation treatment in low viscosity liquids.

In the field of stress relief to component parts and assemblies, especially welded assemblies, there is prior art that discloses the use of low frequency vibrations as well as ultrasonic vibrations. U.S. Pat. No. 7,276,824B2 patent discloses an invention for an impact treatment tool commonly used for peening a targeted weld toe zone or other specific areas with a small diameter impacting tip, e.g. 1.5 to 4 mm radius, that will offer sufficient energy to make focused plastic deformation of the metal surface. US20090049912A1 discloses an invention that applies vibration over a test frequency range, to identify a reference resonance frequency and utilizes that specific frequency to apply stress relieving vibrations. U.S. Pat. No. 7,175,722B2 discloses an invention in which two or more energy types, such as heat and vibration, are concurrently applied to the structure to change the physical property of interest in an accelerated fashion. Other prior art discloses a method to identify a structure's harmonic frequencies and using such information to optimize a driving frequency targeting the specific identified frequency for stress relief. French patent FR1334459A discloses an invention that uses a basic frequency modulated ultrasound wave to reduce stress in metals. The prior art related to impact peening tools utilize an oscillating mass driven by ultrasonic energy to make low frequency sonic hammer energy is very limited in scope of application and can only be applied to a very small target zone, for example in the range of 1 mm to 4 mm diameter tool point that can affect a depth of 1 to 3 mm. Such technology is not suitable for use on a large structure. Such tools only impart low frequency impact energy on a small point and are not designed to treat a large structure or assembly. Furthermore, they do not utilize the type of complex high frequency driving modulations or adaptable resonant frequency methods claimed herein to create a corresponding modulation of the low frequency hammer energy.

Stress relief applications would benefit from a tool that can provide a combination of complex high frequency modulation and/or a corresponding complex low frequency modulation for driving an oscillating striker mass that will significantly broaden the wideband harmonic stimulation of a structure or structure under treatment. There is a need for a simplified tool that can be used without specialized training and can adapt to a wide range of parts and assemblies. A compounded complex modulated high frequency and correspondingly modulated low frequency apparatus would provide such a tool.

In the area of surface cleaning and descaling, attempts have been made to use vibrational forces to reduce fouling. Although ultrasonic solutions may improve some installations there are significant obstacles to achieving universal success. Ultrasonic solutions require rigid coupling to the target vibrated structure, and this is a shortcoming of the clamp-on techniques used by some to couple transducers. Furthermore, when ultrasonic transducers are rigidly fixed to a structure the effective vibration energy delivered to the area where cleaning is required will be severely dampened in larger bodies and assemblies. There exists a particular problem and challenge for cleaning large heat exchangers, large pipes, large bodies and assemblies.

The state of art systems and devices for cleaning large bodies and assemblies face challenges to achieve suitable cleaning of the internal structures and surfaces. Similar challenges are faced by vibration devices used for screen and surface cleaning in wet or dry environments. Accordingly, there is a very large demand across all industries for more efficient and improved solutions to mitigate fouling and cleaning of screens and surfaces.

### SUMMARY

The present invention provides a vibration apparatus and control system aimed at inducing expanded wideband frequency vibration that can stimulate a significantly higher number of harmonic frequencies and vibration modes, e.g. axial, torsional, and radial, in a body or structure. This is accomplished by using compounded complex modulated sonic high frequency vibration in addition to corresponding modulated low frequency impact vibrations or by using complex modulated sonic high frequency vibration to deliver only modulated low frequency impact to a structure. This type of novel wideband vibration energy can be very effective and offer a significant improvement over state-of-the-art solution to deliver acoustic energy into a complex mechanical assembly, for cleaning a mechanical structure or assembly, to mitigate fouling of screens and heat exchangers during operation and can be likewise used as a new type of stress relief regime.

Furthermore, the complex modulated sonic high frequency vibration, and a compounded corresponding low frequency impact vibration provides a novel solution and advantages in liquid processing.

This invention leverages sonic actuators, which operate at lower frequencies than ultrasonic actuators and naturally permit greater axial vibration displacements, often achieving movement 50% to 100% or more compared to ultrasonic actuators. This increased displacement translates directly into a higher energy output, enhancing the efficiency of vibrational energy transfer directly to a structure and to the energy delivered by the low frequency striker. By harnessing the benefits associated with lower-frequency operation, sonic actuators overcome the inherent limitations of ultrasonic systems, providing more robust vibration amplitudes essential for demanding applications such as structural excitation, industrial material processing, and environments where large-scale dynamic interventions are required. The enhanced energy transfer capability afforded by sonic actuators facilitates improved performance, making them particularly advantageous in scenarios where high amplitude vibrations are paramount.

In one aspect, the invention relates to control system capable of providing complex modulated signals that may include modulation techniques such as dynamic sweeping across a range of sonic operating frequencies, dynamic signal amplitude, and programmable pulse width modulation of the driving signals, whereby these modulations may be applied individually or in combination to drive an apparatus that includes a sonic high frequency actuator. Such actuators may include but are not limited to a piezoelectric actuator, a magnetostrictive actuator, a pneumatic actuator, or a rotating motor actuator configured to generate high frequency vibrations with prescribed modulation, and a solid striker configured to oscillate in a corresponding modulated low frequency response to the vibrations generated by the high frequency actuator.

In an embodiment the apparatus may be directly coupled to a structure under treatment so that both sonic high frequency acoustic energy and the oscillating low frequency striker impart combined energy onto the structure at their primary frequencies and at the wide range of stimulated harmonic frequencies.

In another embodiment the apparatus may be indirectly coupled to the structure under treatment so that the modulated low frequency striker is allowed to strike the structure or an element directly coupled to the structure and the sonic high frequency actuator is not coupled to, nor providing high frequency vibration directly to, the structure under treatment.

In still another embodiment the apparatus may be directly coupled to a sonotrode and configured to generate appropriate modulated sonic high frequency vibrations in the sonotrode with sufficient energy to induce dynamic cavitation in a liquid to be treated while simultaneously imparting the low frequency energy derived from the oscillating low frequency striker resulting in delivery of energy across a wideband of harmonic frequencies to a liquid.

In an embodiment, a guide is used to contain the striker mass.

In one embodiment, the striker mass is configured to oscillate between the actuator and a strike zone coupled to or a part of the structure under treatment, the mass having a selected magnitude such that it causes the striker to vibrate at a frequency lower than the sonic high frequency actuator.

In another embodiment, the striker vibrates at an operating frequency that is sonic.

In still another embodiment, a method for cooling the actuator, the striker, and the striker contact zone is provided.

In one further embodiment, the apparatus may utilize and switch between two or more alternative dominant resonant frequencies present in an actuator to affect a corresponding alternative low frequency operation of the striker to further increase the influence of wideband frequency stimulation.

In another embodiment, the apparatus of the invention further includes a mounting method that provides the necessary coupling for imparting sonic high frequency energy and/or the striker low frequency energy.

In still another embodiment, the apparatus of the invention further includes a sensor to measure physical properties of the apparatus components, and/or the striker component, and/or a structure coupled to the actuator, and where sensor data may be used to provide visual feedback information or as feedback data to the apparatus control system.

In one further embodiment, the striker mass, the strike zone, the actuator, and other areas of the apparatus where it is possible that mechanical or electrical sparks may be created, a containment method and/or media such as an inert gas or liquid may be used to suppress such sparks to provide safe operation in explosive environments.

In one embodiment, the striker, the strike zones, and the actuator are contained in a single enclosure where an inert gas media may be used to suppress a sparks.

In another embodiment, the striker and the strike zone are contained in separate containment housing and the actuator is contained in separate containment housing where each may use an inert gas and/or liquid media to suppress sparks.

In a further embodiment, an inert gas or liquid media used to suppress a sparks may also serve to cool the apparatus.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily drawn to scale, like numerals, and describe substantially similar components throughout the several views. Numerals with different letter suffixes represent different instances of substantially similar components. The drawings emphasis is generally being placed upon illustrating the principles of the invention. The drawings illustrate generally, by way of example, but not by way of limitation, various embodiments discussed in the present document.

FIG. 1A illustrates a perspective view of an alternative embodiment of the invention as it would be deployed to be rigidly coupled to a structure to deliver compounded modulated sonic high frequency vibration and corresponding modulated low frequency vibration to a structure.

FIG. 1B illustrates a cross-sectional view of an alternative embodiment of the invention as it would be deployed to be rigidly coupled to a structure to deliver compounded modulated sonic high frequency vibration and corresponding modulated low frequency vibration made by an externally constrained solid striker mass energized by the high frequency vibrations.

FIG. 2 illustrates a cross-sectional view of an alternative embodiment of the invention as it would be deployed to be rigidly coupled to a structure to deliver compounded modulated sonic high frequency vibration and corresponding modulated low frequency vibration made by an internally constrained solid striker mass energized by the high frequency vibrations.

FIG. 3 illustrates a cross-sectional view of an alternative embodiment of the invention as it would be deployed to be in contact with a structure and to deliver only modulated low frequency vibrations to a structure.

FIG. 4 illustrates a cross-sectional view of an alternative embodiment of the invention as it would be deployed to be in contact with a structure via a waveguide rigidly coupled to a structure and to deliver only modulated low frequency vibrations to a structure.

FIG. 5. illustrates a cross-sectional view of an alternative embodiment of the invention as it would be deployed to be near and not rigidly coupled to a structure and to deliver only modulated low frequency vibrations to a structure.

FIG. 6 illustrates an example block diagram of a signal generator that can create complex frequency modulations that may be applied to a high frequency actuator acting on a structure and where a sensor may monitor aspects of the actuator and/or aspects of the structure under treatment.

FIG. 7 illustrates an example of complex frequency modulation that may be applied to a high frequency actuator.

FIG. 8 illustrates an example of complex frequency shift width modulation that may be applied to a high frequency actuator.

FIG. 9 illustrates an example of combined complex modulation that may be applied to a high frequency actuator.

FIG. 10 illustrates an example of pulse width modulation that may be applied to a high frequency actuator.

FIG. 11 illustrates a perspective view of an alternative embodiment of the complex modulated high frequency/low frequency vibration tool coupled to an interior tube bundle as used in a shell-tube heat exchanger.

FIG. 12 illustrates a perspective view of an alternative embodiment of the complex modulated high frequency/low frequency vibration tool coupled to screen.

FIG. 13 illustrates a perspective view of an alternative embodiment of the complex modulated high frequency/low frequency vibration tool coupled to a sonotrode for liquid processing.

FIG. 14 illustrates a perspective view of an alternative embodiment of the complex modulated high frequency/low Frequency vibration tool coupled to a sonotrode for liquid processing.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. The example embodiments may be combined, other embodiments may be utilized, or structural, logical, and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The complex modulated sonic high frequency and low frequency vibration generation tool according to the present teachings uses an axial coupling between a corresponding sonic high frequency actuator and a transmitting element (e.g., waveguide) so to vibrate a striker mass that will oscillate at a lower frequency and respond in a corresponding manner to the complex modulations of the sonic high frequency actuator. The lower frequency striker will provide large impact pulses to a surface in contact with the striker mass and produce an elastic wave that will be transmitted through the contact surface. Furthermore, the low frequency striker mass displacement is normally constrained into the axial direction.

Through control of the complex modulation of the high frequency actuator frequency, amplitude, duty cycle, as well as complex combinations of these modulations and through the corresponding response by the low frequency impactor according to the present teachings, more efficient wideband stimulation of a structure can be provided and more deterministic operation of the transmitting element can be provided. An additional and novel aspect of this complex modulation technique is the ability to apply frequency sweeping techniques that avoid over stimulation of potentially harmful resonance frequencies while in a non-conventional manor simultaneously stimulate adjacent radial and torsional vibration modes that will further expand and stimulate a wideband frequency response in the structure.

Alternatively, when the actuator is of the piezoelectric or magnetostrictive type, through control of the complex modulation of the high frequency the actuator may be operated at one or more of the alternative dominant resonance frequencies.

An optimum operating frequency of the actuator will typically be in the range of 2 kHz to 19.5 kHz. For the purposes of this disclosure, this range is referred to as high-frequency vibrations are within this range. The related low frequency vibration of the striker mass will normally be in the range of 30 Hz to 2,000 Hz. For the purposes of this disclosure, this range is referred to as low-frequency vibrations.

The complex modulated sonic high frequency and low frequency vibration generation tool according to the present teachings may be used as a compounded dynamic dual frequency tool providing both a complex modulated high frequency vibration to a structure and a corresponding modulated low frequency impact vibration to a structure.

Alternatively, the complex modulated sonic high frequency and low frequency vibration generation tool according to the present teachings may be used as a complex modulated lower frequency hammer tool providing a dynamic modulated low frequency impact vibration to a structure.

According to an embodiment of the present disclosure, the striker mass may be positioned between the actuator transmitting element or a waveguide that can be driven to produce high frequency displacement vibration, wherein the distance between a high frequency displacement surface and a striking surface of the transmitting element is fixed, thereby constraining the displacement of the striker mass.

According to another embodiment of the present disclosure, the striker mass may be constrained by a cavity formed inside a waveguide tip that can be driven to produce sonic high frequency displacement. With sufficient displacement energy from the sonic high frequency actuator, for example in the range of 5 micrometers to 10 mm, the constrained and guided striker mass may convert the high frequency displacement into lower frequency strikes on a waveguide or a structure to generate low frequency vibration.

According to an embodiment of the present disclosure, the striker mass may encircle or be constrained by a waveguide structure that can be driven to produce high frequency displacement. With sufficient displacement energy from the high frequency actuator, for example in the range of 5 micrometers to 10 mm, the constrained and guided striker mass may convert the high frequency displacement into lower frequency strikes on a structure to generate low frequency vibration.

According to yet another embodiment of the present disclosure, the striker mass may be constrained by a coupling element that is not rigidly coupled to the actuator and allows the striker mass to engage the actuator causing the striker mass to vibrate at a lower frequency than a frequency of the actuator transmitting element.

According to another embodiment of the present disclosure, the striker mass may be constrained by a coupling to a spring that is in turn coupled to the waveguide tip, causing the striker mass to vibrate at a lower frequency than a frequency of the actuator transmitting element.

According to an embodiment of the present disclosure, the spring may be formed and/or integrated in the horn end tip.

According to another exemplary embodiment, the actuator may be in contact to a spring allowing axial pressure towards the striker mass and axial movement of the actuator assembly.

According to an embodiment the spring compression tension may be adjustable.

According to another embodiment of the present disclosure, the striker mass may be constrained by a flexure.

According to an embodiment of the present disclosure, the flexure has a shape of a diaphragm with a flexure membrane and supporting wall for attachment of the striker mass.

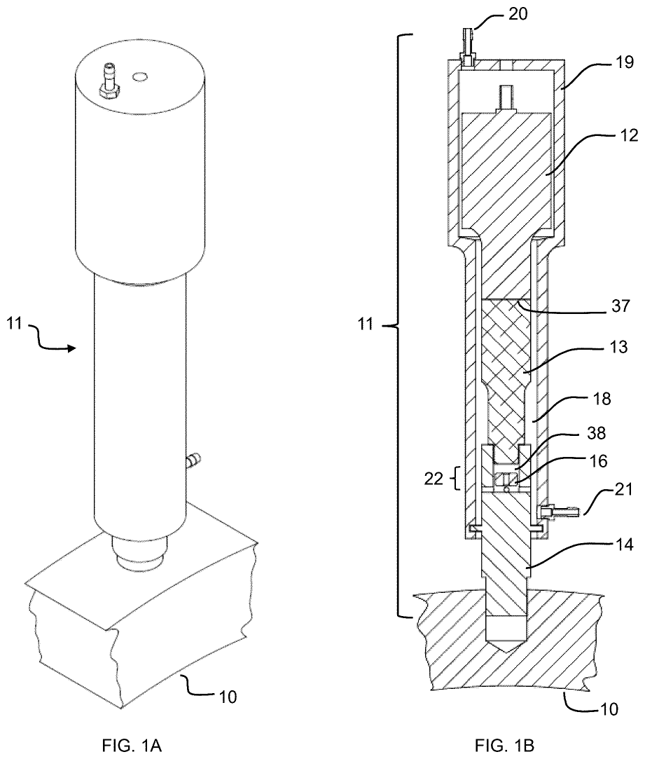

FIG. 1A shows a basic setup of a sonic vibration generation apparatus apparatus (11) according to an embodiment of the present disclosure that is coupled to a structure (10).

FIG. 1B shows a cross-sectional view of an embodiment according to the present disclosure of a compounded complex modulated sonic high frequency and low frequency vibration generation tool (11) using a striker mass (16) whose displacement is constrained into an axial direction by a cavity (17). The tool assembly (11) includes a sonic high frequency actuator (12) an actuator end tip that drives a waveguide (13) that is rigidly coupled to a second waveguide (14) that is rigidly attached to the structure (10) under treatment. The actuator end tip is located at the first axial end of the actuator (12).

As known to a person skilled in the art, design parameters of the waveguide (13) and wave guide (14) can provide a resonance frequency to be same as a resonance frequency of the actuator or a subharmonic of an actuator of the piezoelectric or magnetostrictive type. Accordingly, the tip of the waveguide (13) exposed to the cavity (17) may apply vibrations at resonance or subharmonics of the actuator (12). In turn, the waveguide (13) transmits corresponding sonic high frequency vibrations to the coupled waveguide (14) that in turn transmits corresponding high frequency vibrations to the structure (10).

With continued reference to FIG. 1B, a striker mass (16) is confined within a cavity (17) positioned between the waveguide (13) and waveguide (14). The cavity (17) is specifically designed to permit only axial displacement of the striker mass (16) within predefined limits dictated by the cavity's (22) internal dimensions. When sonic high frequency vibrations are transmitted through the waveguide (13) end tip into the cavity (37), the induced stress is coupled to the striker mass (16), causing it to strike and oscillate between the internal surfaces of the waveguide (13) and waveguide (14). These surfaces, exposed within the cavity (37), are maintained at a fixed distance. Consequently, the striker mass (16) converts the high-frequency sonic vibrations transmitted through the waveguide (13) and waveguide (14) into lower-frequency mechanical impacts, which are then delivered to the structure (10) under treatment.

With further reference to FIG. 1B, according to an exemplary embodiment of the present disclosure, the cavity (38) may be formed inside the end section of a second waveguide (14). It should be noted that the cavity (38) may alternatively (not shown) be formed at the actuator end tip (37) or in the second waveguide (14) where maximum axial vibration energy is found.

It should be further noted that the striker mass (16), according to the present teachings, may have a toroidal shape, however such shape may not be construed as limiting the scope of the present disclosure, as other shapes are within the scope of the invention, so long the cavity (38) is designed to constrain a displacement of the striker mass into an axial direction, thereby providing vibrations in substantially the axial direction. Furthermore, it should be noted that the present teachings are not limited to use of a single striker mass as more than one such mass may be used, for example, within a same cavity or different cavities stacked upon one another.

With continued reference to FIG. 1B further shows an exemplary embodiment of the present disclosure, a containment chamber (19) is provided to enclose the actuator (12), the striker (16), the strike zone surfaces within the cavity (38), and other areas of the apparatus where it is possible that mechanical or electrical sparks may be created. This containment chamber (19) may create a sealed area (18) where a media such as an inert gas or liquid may be used to suppress or contain such sparks to provide safe operation in explosive environments. The containment chamber (19) further provides optional inlet/outlet (20) and optional inlet/outlet (21) to allows a flowable media (liquid or gas) to further aid in cooling of the elements in contact with the media. Alternatively, this containment chamber (19) may be sealed without inlet/outlet (20) and optional inlet/outlet (21) to restrict exposure of internal elements to any external gas or environmental elements.

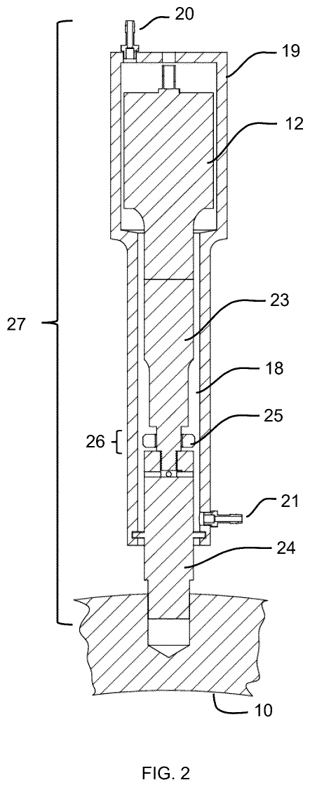

FIG. 2 shows another exemplary embodiment, where the striker mass (25) has a toroidal shape with an internal diameter to allow insertion over a reduced diameter of the end tip of waveguide (23) that is rigidly coupled to a mating end of waveguide (24) that has a larger end diameter to form a fixed distance (26) whereby the striker mass (25) is constrained to axial movement between waveguide (23) and the mating end of waveguide (24).

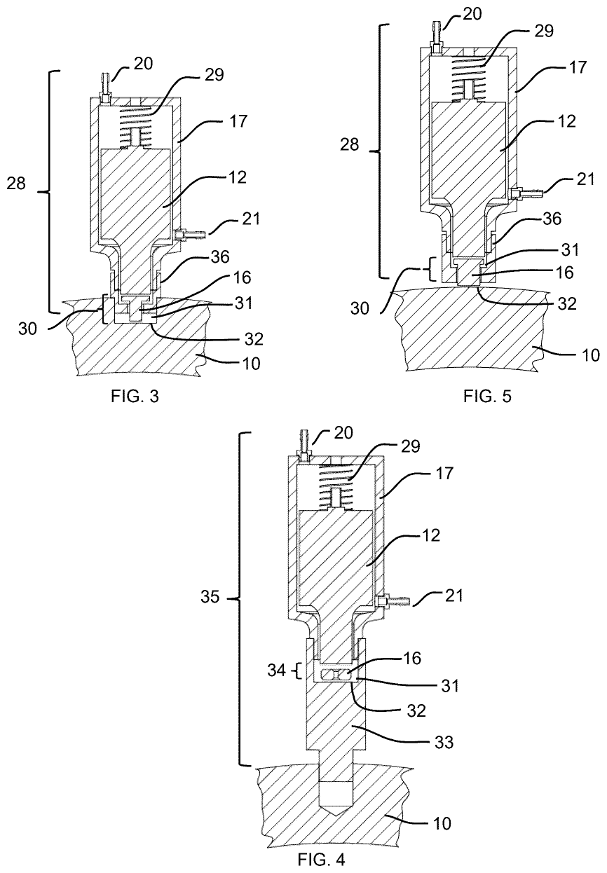

FIG. 3 shows another exemplary embodiment of an vibration generation apparatus (28), where the actuator (12) is indirectly coupled to a structure (10) via a housing (17) and a coupling element (36) wherein the actuator (12) is free to move axially within the confines of the housing (17). A spring (29) is used to provide pressure engagement between the actuator (12) end tip and the impact mass (16). The impact mass (16) is constrained by a cavity (31) formed in the coupling element (36) and the structure (10) and constrained to move axially. The distance (30) between the actuator (12) end tip and the structure strike surface (32) is variable with a minimum distance equal to the thickness of the striker mass (16) and a maximum distance (30) that is dependent on the spring (29) characteristics and the vibrational energy provided by the actuator (12). In this embodiment only low frequency vibration energy is delivered to a structure (10).

FIG. 4 shows another exemplary embodiment of a vibration generation apparatus (35), where the actuator (12) is indirectly coupled to a waveguide (33) via a housing (17) that is coupled to waveguide (33) that is rigidly coupled to a structure (10). The actuator (12) is free to move axially within the confines of the housing (17). A spring (29) is used to provide pressure engagement between the actuator (12) tip and the impact mass (16). The impact mass (16) is constrained by a cavity (31) formed by the end tip of the actuator (12) and the upper end of waveguide (33) and constrained to move axially. The distance (34) between the actuator (12) end tip and the waveguide (33) upper end strike surface (32) is variable with a minimum distance equal to the thickness of the striker mass (16) and a maximum distance (34) that is dependent on the spring (29) characteristics and the vibrational energy provided by the actuator (12).

In this embodiment only low frequency vibration energy is transmitted from the striker mass (16) to the waveguide strike surface (32) and transmitted to structure (10).

FIG. 5 shows another exemplary embodiment, where the vibration generation apparatus (28) is in close proximity or adjacent to and not coupled to a structure (10) and where the actuator (12) is free to move axially within the confines of the housing (17). A spring (29) is used to provide pressure engagement between the actuator (12) end tip and the impact mass (16). The impact mass (16) is constrained by a cavity (31) formed in a coupling element (36) and constrained to move axially. The distance (30) between the actuator (12) end tip and the structure strike surface (32) is variable with a minimum distance equal to the thickness of the striker mass (16) and a maximum distance (30) that is dependent on the spring (29) characteristics and the vibrational energy provided by the actuator (12). In this embodiment only low frequency vibration energy is delivered to a structure (10) when engagement contact is made.

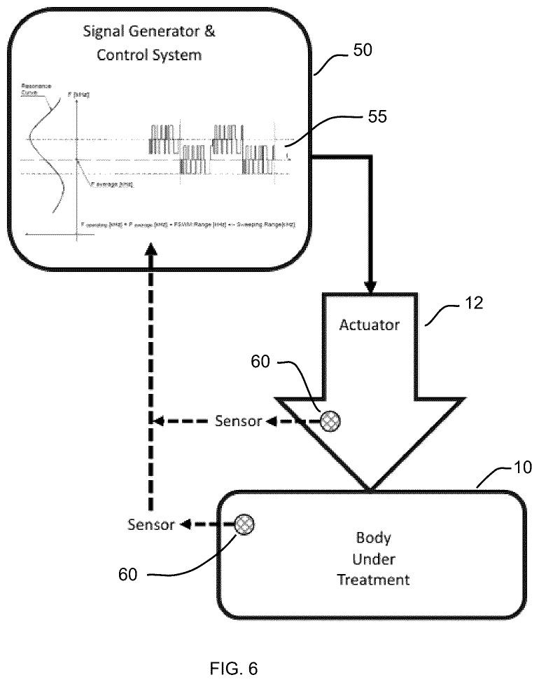

FIG. 6 illustrates an example block diagram of a signal generator and control system, also referred to as the control system (50), that can create complex frequency modulations (55) that are applied to a high frequency or low frequency actuator (12) acting on a structure. The actuator (12) can include one or more sensors (60) and where the one or more sensor may monitor aspects of the actuator and/or aspects of the structure under treatment. The aspects monitored by the sensors (60) can include, but are not limited to, the frequencies being induced into a body or structure under treatment (10) the temperature of the actuator, and the temperature of any cooling fluid. Such sensors information may be displayed visually on the control system, transmitted to a remote location, or may be used by the control system to adapt and optimize actuator driver modulation signals. The control system (50) can output an amplified electrical system with sufficient energy to drive the actuator (12). The control system can include electronics to select high frequency or low frequency patterns and an amplifier to drive the electrical signal to a piezoelectric actuator, a magnetostrictive actuator, a pneumatic actuator, or a rotating motor actuator to generate high frequency vibrations with prescribed modulation, and a solid striker configured to oscillate in a corresponding modulated low frequency response to the vibrations generated by the high frequency actuator. A person of ordinary skill in the art of building sonic or ultrasonic systems would know how to build a control system for a piezoelectric actuator, a magnetostrictive actuator, a pneumatic actuator, or a rotating motor actuator.

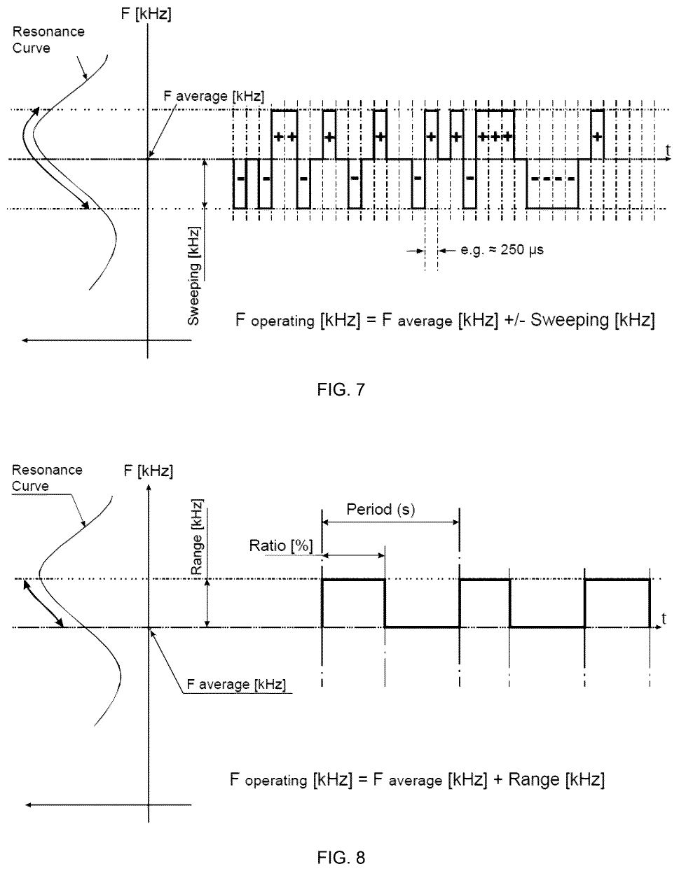

FIG. 7 shows a diagram depicting an example of a complex sweeping modulation signal for driving the apparatus high frequency actuator. A complex sweeping modulation may increase or decrease the average operating frequency (F) in a programmable fixed periodic sequence or in a random sequence as shown. The operating frequency may be calculated as follows:

$$F operating [ kHz ] = F average [ kHz ] \text{+/-} Sweeping [ kHz ]$$

FIG. 8 shows a diagram depicting an example of a complex frequency shift width modulation (FSWM) signal for driving the apparatus high frequency actuator. A complex frequency shift width modulation signal may increase the average operating frequency range [Hz] periodically with a programmable period [seconds] and ratio [%]. The operating frequency may be calculated as follows:

$$F operating [ kHz ] = F average [ kHz ] + Range [ kHz ]$$

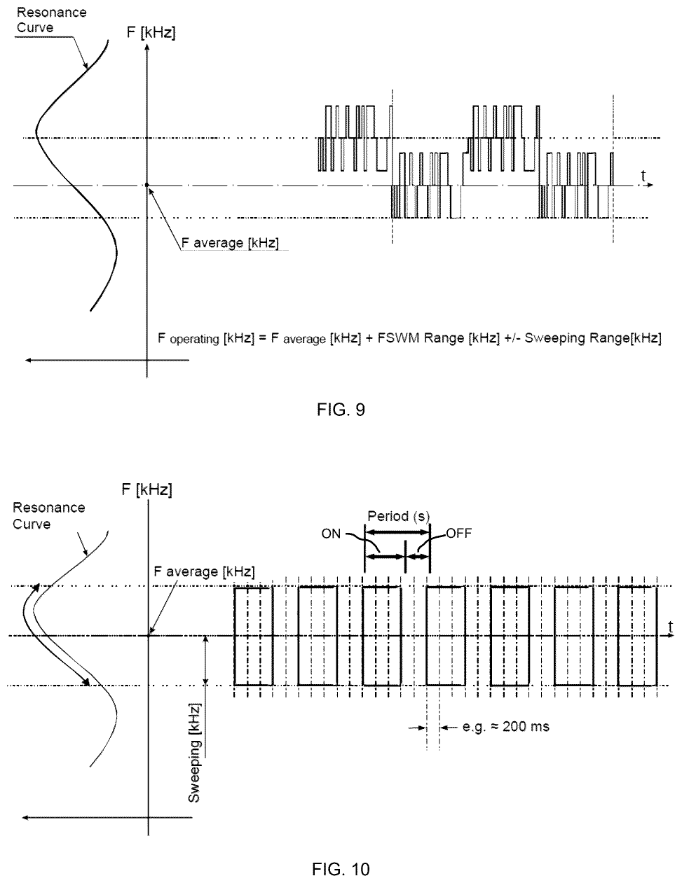

FIG. 9 shows a diagram depicting an example of a complex modulation combining frequency shift width modulation (FSWM) and sweeping modulation to create a new type of signal for driving the apparatus high frequency actuator. Such a complex modulation may be a programmable mathematical sum of FSWM and Sweeping modulations.

$$F operating [ kHz ] = F average [ kHz ] + FSWM Range [ kHz ] \text{+/-} Sweeping Range [ kHz ]$$

FIG. 10 shows a diagram depicting an example of a complex modulation using pulse width modulation (PWM) with a programmable period (e.g. 1 second) and a programmable duty cycle (e.g. 60%) that provides and On/Off periodic cycle as shown. This modulation may be further combined with the other complex modulations individually or in any combination.

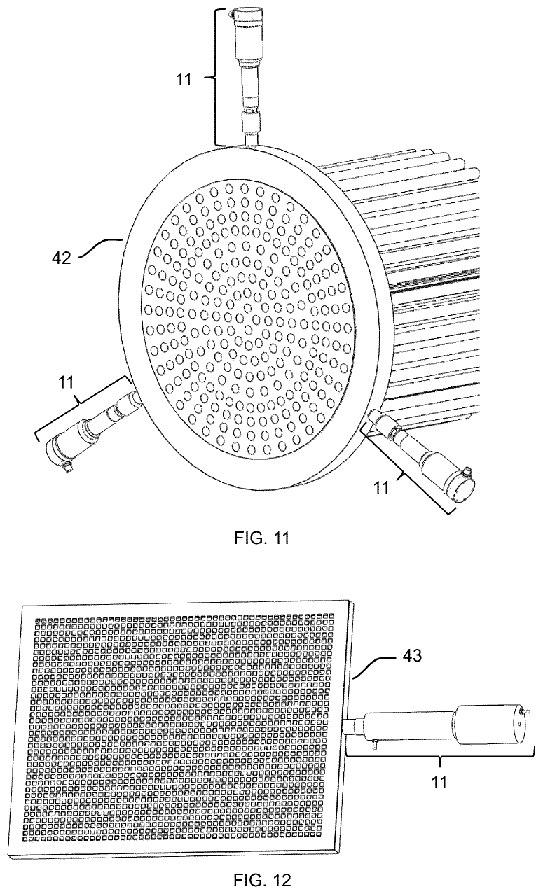

FIG. 11 shows another exemplary embodiment, depicting a vibration generation apparatus (11) according to an embodiment of the present disclosure that is coupled to a heat exchanger tube bundle (42).

FIG. 12 shows another exemplary embodiment, depicting a vibration generation apparatus (11) according to an embodiment of the present disclosure that is coupled to a screen assembly (43).

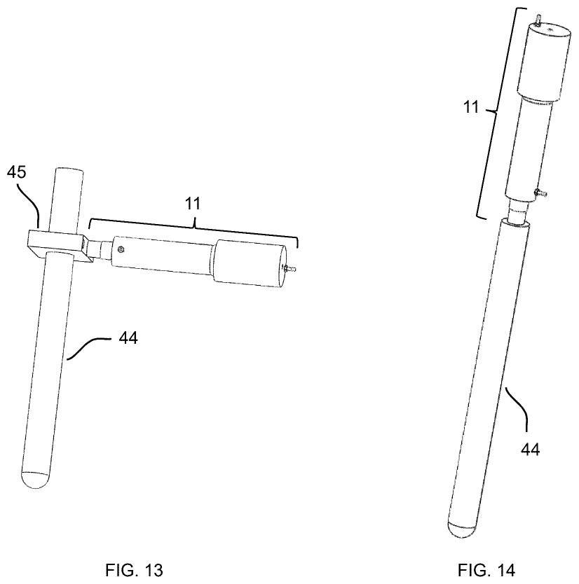

FIG. 13 shows another exemplary embodiment, depicting a vibration generation apparatus (11) according to an embodiment of the present disclosure that is coupled to a liquid processing sonotrode (44) via a rigidly connected clamping element (45).

FIG. 14 shows another exemplary embodiment, depicting a vibration generation apparatus (11) according to an embodiment of the present disclosure that is directly coupled to a liquid processing sonotrode (44).

What is claimed:

1. A vibration generation apparatus comprising:
a control system configured to generate a configurable complex sonic high-frequency driving signals;
an actuator comprising:
an actuator end tip at a first axial end of the actuator; and
a connection to the control system, the actuator adapted to generate complex modulated sonic high-frequency vibrations at a predetermined frequency and amplitude when receiving complex high-frequency driving signals;
a waveguide rigidly coupled to an actuator end tip; and
a striker mass disposed between said actuator first axial end and said waveguide, the striker mass configured to engage the actuator end tip thereby converting the complex modulated sonic high-frequency vibrations into corresponding modulated complex lower frequency hammering impacts transmitted to the waveguide, and wherein the waveguide is configured to transmit to its distal end the combined vibrations comprising the complex modulated sonic high-frequency vibrations generated by said actuator and the corresponding modulated complex lower frequency hammering impacts produced by said free striker mass.

2. The apparatus of claim 1 further comprising a structure, wherein the actuator assembly is rigidly affixed to the structure, ensuring direct transmission of the complex modulated sonic high-frequency vibrations and the modulated complex lower frequency hammering impacts for causing wideband frequency vibrations in the structure.

3. The apparatus of claim 2, wherein the wideband frequency vibrations induce shear forces between the structure surfaces and attached contaminants or adjacent materials, thereby facilitating cleaning.

4. The apparatus of claim 2, wherein the control system is configured to generate the complex high-frequency driving signals, wherein said wideband frequency vibrations may be applied to the coupled structure to induce mechanical stress relief in the structure by facilitating microstructural modifications or residual stress redistribution.

5. The apparatus of claim 2, wherein the control system is configured to drive the actuator at a high-frequency vibration level sufficient to induce a corresponding vibration amplitude in the coupled structure, wherein said vibration amplitude, when transmitted to a liquid medium in contact with the structure, generates cavitation within said liquid medium.

6. The apparatus of claim 2, wherein the controller is configured to generate complex modulation of the high frequency actuator vibrations that minimize the resonance frequencies in the structure.

7. The apparatus of claim 1, wherein the striker mass has a striker mass shape and a striker mass weight that are configurable to change the frequency of the modulated low frequency hammering.

8. The apparatus of claim 1, wherein the control system is configured to switch between one or more dominant actuator resonant frequencies, each of the one or more resonant frequencies configured and controlled to generate different high frequency stimulation in combination with the low frequency hammering thereby increasing the wideband frequency stimulation.

9. The apparatus of claim 1, further comprising a control system and one or more sensors, wherein the control system is configured to communicate with said sensor(s), and wherein the sensor(s) are adapted to measure physical properties of the actuator, its individual components, and/or the striker, and/or any object influenced by the actuator or striker, Said measurements may include vibration acceleration, vibration velocity, vibration displacement, vibration frequency, temperature, waveform characteristics, spectral analysis, force, pressure, strain, impedance, acoustic emissions, humidity, environmental conditions, and resonance detection, The control system processes such measurements to optimize operational parameters, thereby achieving predetermined vibration conditions of a structure under treatment.

10. A vibration generation apparatus comprising:
a control system configured to generate a configurable complex sonic high-frequency driving signals;
an actuator comprising:
an actuator end tip at a first axial end of the actuator; and
a connection to the control system, the actuator adapted to generate complex modulated sonic high-frequency vibrations at a predetermined frequency and amplitude when receiving complex high-frequency driving signals;
a coupling element not rigidly coupled to said actuator first axial end; and
a striker mass disposed between said actuator first axial end and said coupling element;
wherein the free striker mass is configured to engage the actuator end tip thereby converting the complex modulated sonic high-frequency vibrations into corresponding modulated complex lower frequency hammering impacts.

11. The apparatus of claim 10, wherein the actuator assembly is positioned proximal to a structure, and wherein either the striker mass or the coupling element or both are in direct contact with the structure, facilitating the direct transmission of modulated complex lower-frequency hammering impacts that induce wideband frequency vibrational excitation within the structure.

12. The apparatus of claim 11, wherein the apparatus is configured to generate wideband frequency vibrations into the structure and to induce shear forces between the structure surfaces and attached contaminants or adjacent materials, thereby facilitating cleaning.

13. The apparatus of claim 11, wherein the control system is configured to generate the complex high-frequency driving signals disposed to generate wideband frequency vibrations that induce mechanical stress relief in the structure by facilitating microstructural modifications or residual stress redistribution.

14. The apparatus of claim 11, wherein the controller is configured to generate proportionally corresponding modulated complex lower frequency hammering impact vibrations that minimize the resonance frequencies in the body.

15. The apparatus of claim 10, wherein the striker mass has a striker mass shape and a striker weight that are configurable to change the frequency of the modulated low frequency hammering.

16. The apparatus of claim 10, wherein the control system is configured to switch between one or more dominant resonant frequencies, each of the one or more resonant frequencies configured and controlled to generate different wideband high frequency vibrations thereby and wherein the controller is configured to control the striker frequency thereby increasing the effect of the wideband frequency vibrations.

17. The apparatus of claim 10, further comprising a control system and one or more sensors, wherein the control system is configured to communicate with said sensor(s), and wherein the sensor(s) are adapted to measure physical properties of the actuator, its individual components, and/or the striker, and/or any object influenced by the actuator or striker, Said measurements may include vibration acceleration, vibration velocity, vibration displacement, vibration frequency, temperature, waveform characteristics, spectral analysis, force, pressure, strain, impedance, acoustic emissions, humidity, environmental conditions, and resonance detection, The control system processes such measurements to optimize operational parameters, thereby achieving predetermined vibration conditions of a body under treatment.
